(19) United States
(12) Patent Application Publication
(10) Pub. No.: US 2025/0042344 A1
(43) Pub. Date: Feb. 6, 2025

(54) HITCH STORAGE AND SUPPORT APPARTUS AND METHOD OF MAKING

(71) Applicant: Steven Ladosz, Simcoe (CA)

(72) Inventor: Steven Ladosz, Simcoe (CA)

(21) Appl. No.: 18/230,153

(22) Filed: Aug. 3, 2023

(51) Int. Cl. B60R 11/06; B60D 1/58

(52) U.S. Cl. CPC B60R 11/06; B60D 1/58

(57) ABSTRACT

A hitch support and organizing apparatus includes a sheet of metal, with two portions bent inwardly at 90 degrees to a third portion therebetween. The two bent portions are substantially parallel with one another and have one or more pairs of feature openings substantially aligned between them. The third portion has feature openings that are configured to receive mounting hardware used to mount the third portion of the apparatus to a wall or support surface. Once mounted to the wall, the one or pairs of aligned features are configured to accommodate and support one ore more hitches and their respective hitch pins.

### FIELD OF THE INVENTION

This invention relates generally to the storage and support of hitches, and more particularly to a hitch support structure that can be coupled to a support surface such as those that form a truck bed or tool box.

### BACKGROUND OF THE INVENTION

Many people use pick-up trucks for pulling or towing using hitches. Often, the hitches are left lying freely inside of a truck bed. Thus, they are susceptible to colliding with walls of the truck bed when the driver takes hard turns or brakes abruptly. While it is desirable to have them available within the vehicle, allowing them to slide or roll around freely in the truck bed is not ideal for many reasons. It would be desirable to make hitches easier to retrieve for use and to easily store them in an organized configuration where they can be restrained from freely roaming around the truck bad.

### SUMMARY OF THE INVENTION

A hitch storage and support apparatus includes a sheet of metal having a first and second portion each being bent at 90 degrees from a third portion therebetween, the first and second portions being substantially parallel with one another, the first and second portions each having one more feature openings therein, each of the one or more openings of the first portion being aligned with a different one of the one or openings of the second portion, each the one or more aligned features being configured dimensionally to accommodate and support a hitch. The portion includes one or more features configured to accommodate hardware to mount the apparatus to a wall.

### BRIEF DESCRIPTION OF THE DRAWINGS

Many additional features and advantages will become apparent to those skilled in the art upon reading the following description, when considered in conjunction with the accompanying drawings, wherein:

FIG. 1A is a plan view of an embodiment of the invention that can support two hitches wherein features have been laser cut from a flat sheet of metal, but before it's bent into its operable configuration;

FIG. 1B is a side view of the embodiment of FIG. 1A after bends have been made along the bend lines;

FIG. 1C is a top view of the embodiment of FIGS. 1A-B;

FIG. 1D is a front view of the embodiment of FIGS. 1A-C;

FIG. 1E is a view of the embodiment of FIGS. 1A-E including one possible set of dimensions for the embodiment.

FIG. 1F is a view of the embodiment of FIGS. 1A-E supporting one of a possible two hitches.

FIG. 2A is a view of an embodiment of the invention that supports a single hitch.

FIG. 2B is a front view of the embodiment of FIG. 2A.

FIG. 2C is a top view of the embodiment of FIGS. 2A-B.

FIG. 2D is a side view of the embodiment of FIGS. 2A-C.

FIG. 2E is a plan view of one possible dimensional configuration of the embodiment of the invention of FIGS. 2A-D, wherein features have been laser cut from a flat sheet of metal, but before it's bent into its operable configuration.

### DETAILED DESCRIPTION

Embodiments of a hitch storage and support apparatus are disclosed. The embodiments can be mounted to any wall of or surface capable of supporting the invention and hitches stored thereon, using coupling components such as 4¼″×1½″ manufacturer supplied self-tapping screws. This makes mounting easy and can be performed with commonly owned tools and little mechanical skills. Coupling components such as self-tapping screws can be mounted through plastic bed liners along with a wide range of other materials and can be mounted to surfaces with minor curvatures.

The disclosed embodiments can be adapted, with at most minor changes in dimensions, to work with many different models of truck beds, as well as installation in walls of an RV Storage compartment, garage, work van, cargo trailer and truck bed tool box. In addition, embodiments can be configured to support from one to several hitches at once.

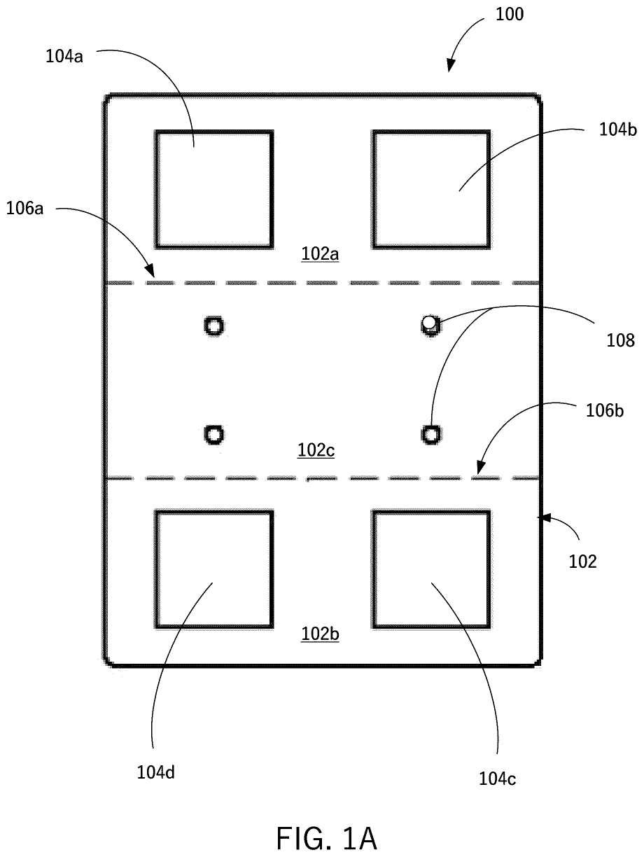

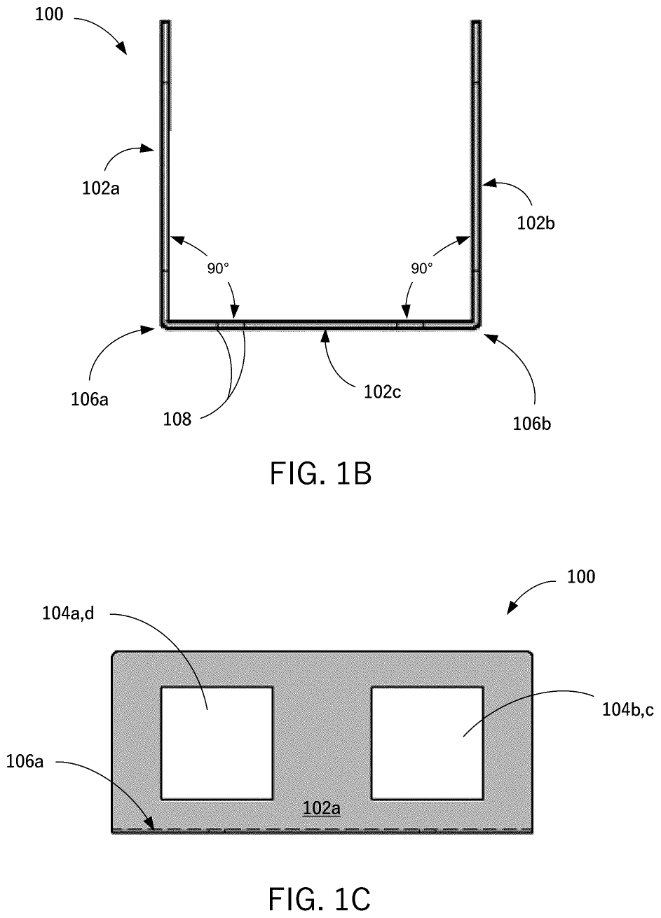

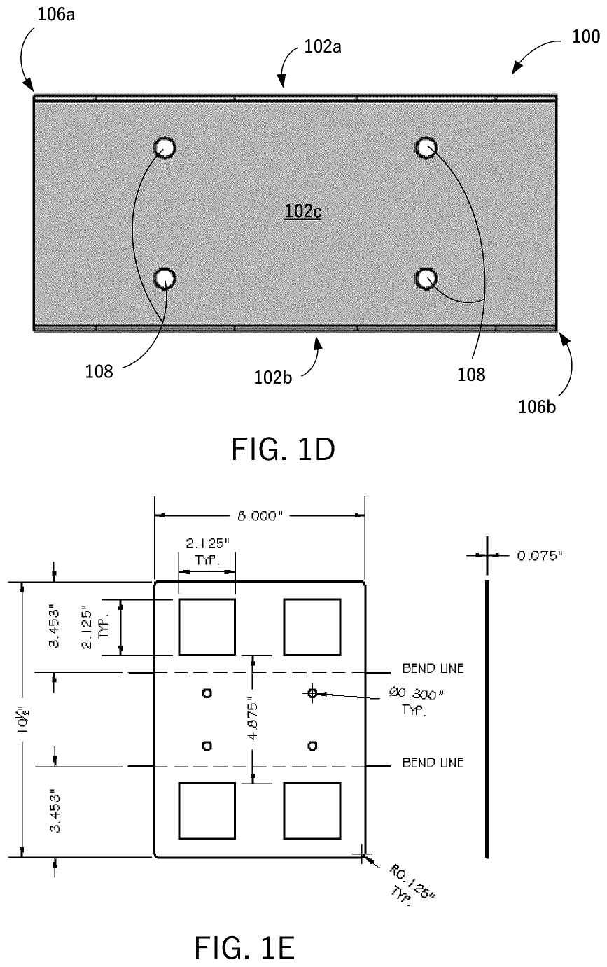

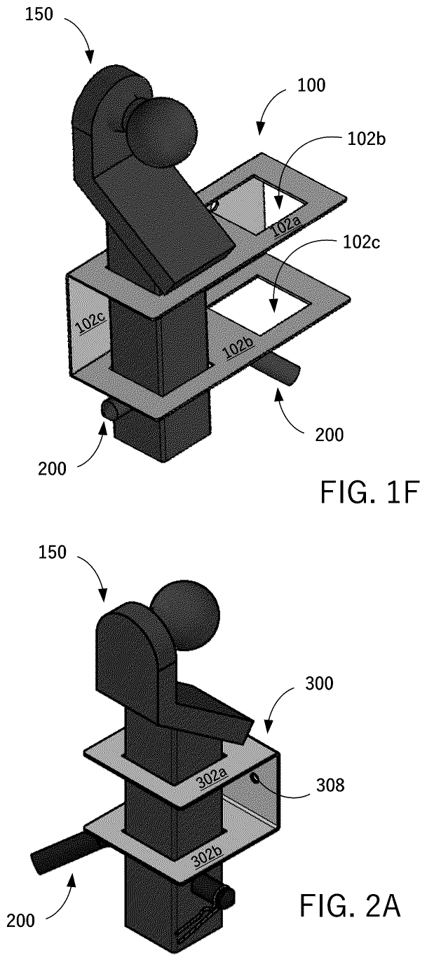

With reference to FIG. 1, a first embodiment 100 of the invention is illustrated that can support two hitches with their respective hitch pins. FIG. 1 shows a flat sheet 200 of metal (such as 14 gauge), out of which features 104a-d have been laser cut to accommodate the hitches, and 4 holes 108 are provided as openings to accommodate the mounting components. Bend lines 106a and 106b are illustrated, along which the metal will be bent inwardly until portions 200a and 200b of sheet 200 as defined by the bend lines are at roughly 90 degrees to the original plane of the sheet of metal 200, and portion 200c of sheet 200. Thus, portions 200a and 200b are approximately parallel with one another. As such, features 104a, d and features 104b, c are each roughly aligned with one another.

Those of skill in the art will recognize that the features can be shapes other than square, and the area of the features can also be varied to accommodate the geometric shape of hitches they are intended to support.

FIG. 1B shows a side view of after the bends have been made. Those of skill in the art will recognize that other angles may also be employed, perhaps to deliberately cause the pairs of features 104a,d and 104b,c to not be perfectly aligned.

FIG. 1C shows a top view that illustrates the alignment of the two pairs of features.

FIG. 1D shows a front view of the invention that illustrates the features for accommodating the mounting components that will couple the portion 102c to the support surface.

FIG. 1E illustrates sheet 200 in its pre-bended state, and one possible dimensional configuration of the components.

FIG. F shoes the configured device 100 accommodating one of a possible two hitches 150 and it's hitch pin 200, through one pair of aligned features 104a,d. Those of skill in the art will appreciate that as shown, the feature 104a is configured to accommodate the hitch until the hitch becomes larger than feature 104a. Feature 104a then causes the weight of the hitch to be supported by device 100 as the hitch rests on portion 102a. Feature 104d retains the remaining portion of the hitch to prevent it from moving from side to side. Those of skill will recognize that the hitch pin 200 could be used to provide support to the hitch 150 against portion 102b if desired if the hitch pin 200 is inserted into its retention holes while the hitch pin retention holes (not shown) remain between the two portions 102a,b.

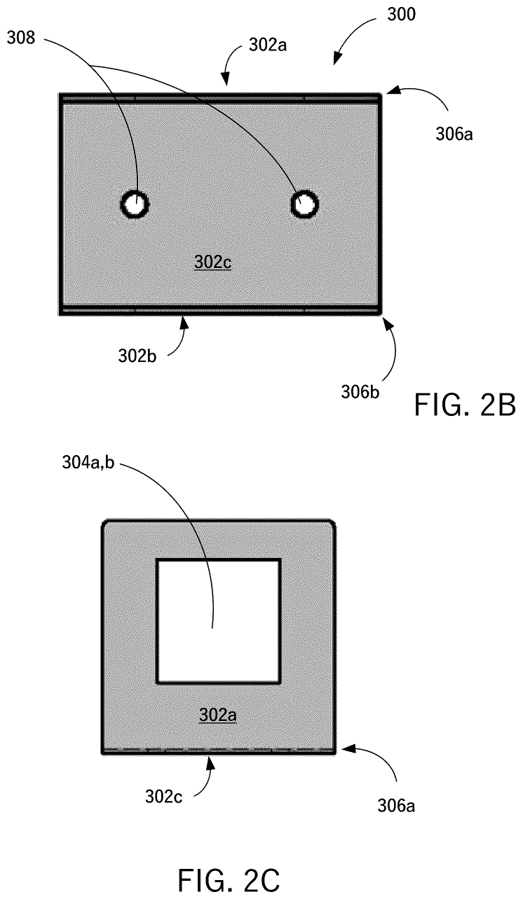

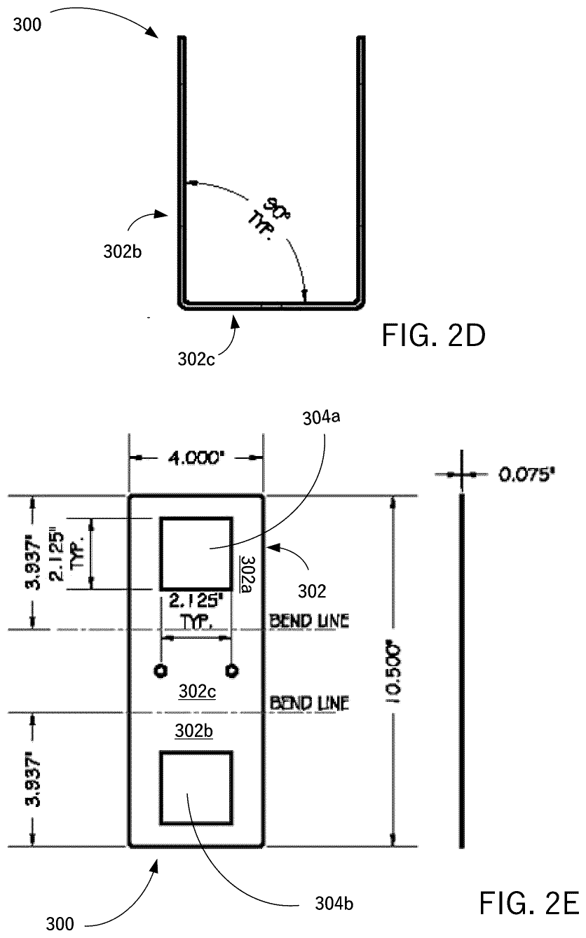

FIG. 2A shows a second embodiment 300 of the invention that can accommodate a single hitch 150, and inserted into the feature at a different orientation to the features.

FIG. 2B shows a front view illustrating two holes 308 for accommodating mounting hardware to support the weight of a single hitch 150.

FIG. 2C shows a top view of the single hitch support embodiment 300 illustrating a single pair of aligned features 304a,b by which to receive and support a single hitch.

FIG. 2D illustrates a side view of the single hitch support embodiment 300.

FIG. 2E shows the single hitch support embodiment before the bends have been made. FIG. 2E further illustrates one possible dimensional configuration of the single hitch embodiment that can accommodate one or more possible hitch sizes. Those of skill in the art will recognize that changes can be made in the dimensions of the invention to accommodate other sizes of hitches and hitch pins without deviating from the intended scope of the invention. In addition, other materials can be used substituted for sheet metal when appropriate, as well as the number and type of mounting components when dictated by the size, weight, and geometric shapes of the hitches.

Other modifications and implementations will occur to those skilled in the art without departing from the spirit and the scope of the invention as claimed. Accordingly, the above description is not intended to limit the invention, except as indicated in the following claims.

What is claimed is:

1. A hitch storage and support apparatus comprising:
a sheet of metal having:
a first and second portion each being bent at 90 degrees from a third portion therebetween, the first and second portions being substantially parallel with one another, the first and second portions each having one more feature openings therein, each of the one or more openings of the first portion being aligned with a different one of the one or openings of the second portion, each the one or more aligned features being configured dimensionally to accommodate and support a hitch, and
wherein the third portion includes one or more features configured to accommodate hardware to mount the apparatus to a wall.
